(19) United States
(12) Patent Application Publication
(10) Pub. No.: US 2026/0160349 A1
(43) Pub. Date: Jun. 11, 2026

(54) METHODS AND APPARATUS TO DETECT PRESSURE RELIEF VALVES NEARING ACTIVATION

(71) Applicant: Emerson Automation Solutions Final Control US LP, Houston, TX (US)

(72) Inventors: Marcelo Luis Dultra, Tomball, TX (US); Ravali Kavya Bhavaraju, Sugar Land, TX (US); Ricardo Jose Garcia, Katy, TX (US)

(21) Appl. No.: 18/971,499

(22) Filed: Dec. 6, 2024

(51) Int. Cl. F16K 15/18; G05D 7/06

(52) U.S. Cl. CPC F16K 15/18; G05D 7/0617

(57) ABSTRACT

Systems, apparatus, articles of manufacture, and methods are disclosed to detect pressure relief valves nearing activation. An example computing device includes interface circuitry, machine readable instructions, and programmable circuitry to at least one of instantiate or execute the machine readable instructions to obtain pressure data from a pressure sensor, the pressure data associated with a differential pressure between a first area of a pressure relief valve and a second area of the pressure relief valve, the first area different than the second area, to obtain setpoint data corresponding to a threshold pressure and an activation pressure of the pressure relief valve, to determine if the differential pressure is between the threshold pressure and the activation pressure based on the pressure data and the setpoint data, and to generate an indication corresponding to the differential pressure being between the threshold pressure and the activation pressure.

### FIELD OF THE DISCLOSURE

This disclosure relates generally to fluid valves and, more particularly, to methods and apparatus to detect pressure relief valves nearing activation.

### BACKGROUND

Pressure relief valves are typically used in pressurized fluid systems to maintain safe levels of fluid pressure. When the pressure inside the system passes a threshold level, the pressure relief valve opens to release fluid, thereby reducing pressure within the system. Pilot operated pressure relief valves feedback system pressure to the valve seat to increase sealing force to reduce leakage at system pressures near the threshold level. Modulating pilot operated pressure relief valves are configured to open gradually in proportion to the difference between the system pressure and the threshold pressure. In this way, modulating pilot operated pressure release valves reduce a total volume of fluid released in response to system pressure exceeding the threshold pressure.

### BRIEF DESCRIPTION OF THE DRAWINGS

FIG. 1 is a block diagram of an example environment in which an example controller operates to determine operational states of example pressure relief valves in an example fluid system.

FIG. 2 is a block diagram of an example implementation of the controller of FIG. 1.

FIGS. 3A-3C are illustrations of an example pressure relief valve in an example closed state, an example proportional release state, and an example maximum release state.

FIGS. 4A-4B are example operational charts that can be used to determine operational states of the example pressure relief valves of FIG. 1.

FIGS. 5-6 are flowcharts representative of example machine readable instructions and/or example operations that may be executed, instantiated, and/or performed by example programmable circuitry to implement the controller of FIG. 2.

FIG. 7 is a block diagram of an example processing platform including programmable circuitry structured to execute, instantiate, and/or perform the example machine readable instructions and/or perform the example operations of FIGS. 5 and/or 6 to implement the controller of FIG. 2.

FIG. 8 is a block diagram of an example implementation of the programmable circuitry of FIG. 7.

FIG. 9 is a block diagram of another example implementation of the programmable circuitry of FIG. 7.

In general, the same reference numbers will be used throughout the drawing(s) and accompanying written description to refer to the same or like parts. The figures are not necessarily to scale. Instead, the thickness of the layers or regions may be enlarged in the drawings.

### DETAILED DESCRIPTION

Complex fluid systems, such as industrial systems, often include pressure vessels that are monitored remotely. Control systems collect data from sensors within the fluid system to monitor and control the associated processes and pressure vessels. Pressure relief valves are often monitored to determine if the pressure relief valves are activating in response to pressures over a threshold pressure within pressure vessels.

In some applications, it is advantageous to detect when a pressure relief valve is about to activate and/or the pressure in a fluid vessel is nearing the pressure relief valve activation pressure. Known control systems do not provide notice that a pressure relief valve is about to activate. Monitoring pressure relief valves that are near activation is challenging in large fluid systems that have many pressure relief valves having different activation pressures.

Methods and apparatus disclosed herein monitor differential pressure measurements across a valve member in a pressure relief valve to determine if the pressure relief valve is nearing an activation state. In this way, the control system may notify a user or otherwise adjust operation of the fluid system in anticipation of an activation of the pressure relief valve.

Example methods and apparatus disclosed herein include a computing device including interface circuitry, machine readable instructions, and programmable circuitry to at least one of instantiate or execute the machine readable instructions to obtain pressure data from a pressure sensor, the pressure data associated with a differential pressure between a first area of a pressure relief valve and a second area of the pressure relief valve, the first area different than the second area, to obtain setpoint data corresponding to a threshold pressure and an activation pressure of the pressure relief valve, to determine if the differential pressure is between the threshold pressure and the activation pressure based on the pressure data and the setpoint data, and to generate an indication corresponding to the differential pressure being between the threshold pressure and the activation pressure.

Example methods and apparatus disclosed herein includes a non-transitory machine readable storage medium comprising instructions to cause programmable circuitry to at least obtain sensor identification data corresponding to a sensor operatively coupled to a pressure relief valve within a fluid system, the pressure relief valve coupled to a pressure vessel, obtain setpoint data corresponding to an activation differential pressure of the pressure relief valve, obtain pressure data from the sensor, the pressure data corresponding to a differential pressure across a flow control member within the pressure relief valve, the flow control member to selectively fluidly couple and selectively isolate an inlet of the pressure relief valve from an outlet of the pressure relief valve based on the differential pressure rising above or falling below the activation differential pressure of the pressure relief valve, and determine a state of the pressure relief valve based on the sensor identification data, the setpoint data, and the pressure data.

Example methods and apparatus disclosed herein include a method of detecting a pressure relief valve nearing activation including receiving sensor data corresponding to an identification of a pressure sensor within a fluid system, the pressure sensor to measure pressure within the pressure relief valve, the pressure relief valve including an inlet and a dome, receiving setpoint data corresponding to an activation pressure of the pressure relief valve, receiving pressure data from the pressure sensor, and determining if the pressure relief valve is nearing activation based on the sensor data, the pressure data, and the setpoint data.

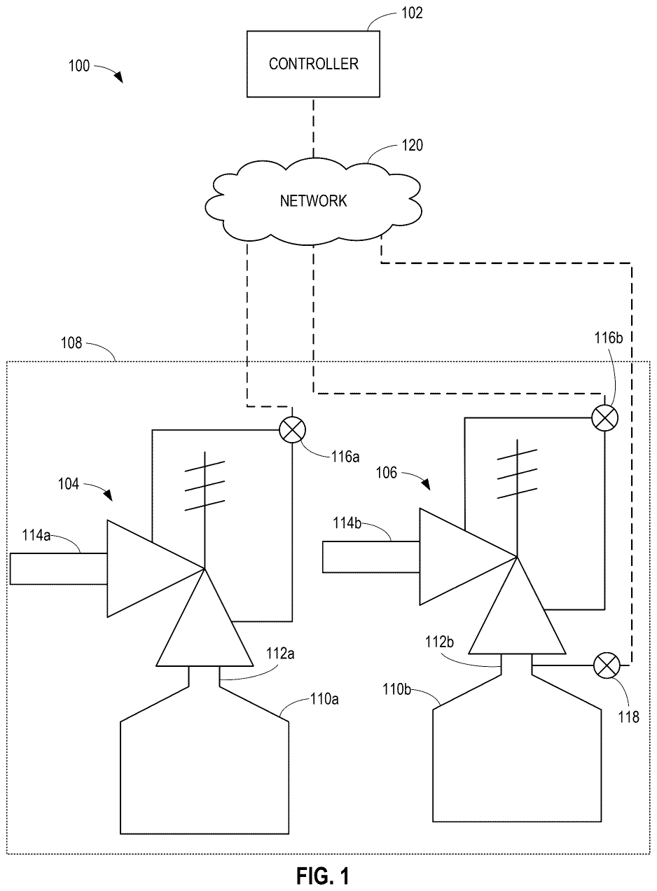

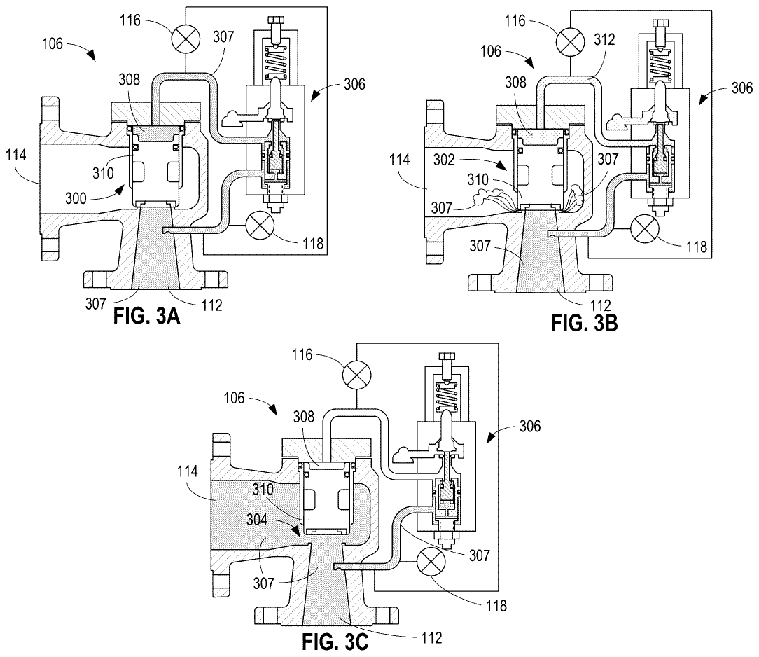

FIG. 1 is a block diagram of an example environment 100 in which an example controller 102 operates to determine operational states of example pressure relief valves (PRV) 104,106 in an example fluid system 108. The example fluid system 108 includes example pressure vessels (e.g., fluid vessels, fluid containers, etc.) 110a,110b. The PRVs 104,106 fluidly couple to the pressure vessels 110a,110b via example inlets 112a,112b. The PRVs 104,106 release fluids from the pressure vessels 110a,110b through example outlets 114a,114b when a pressure of the fluids reaches a threshold, as explained in more detail below in reference to FIGS. 3A-3C.

The PRV 104 includes an example differential pressure sensor 116a to measure a pressure difference (e.g., a differential pressure) within the PRV 104. The PRV 106 includes an example differential pressure sensor 116b to measure a pressure difference within the PRV 106 and an example pressure sensor 118 to measure a pressure (e.g., a gauge pressure) within the inlet 112b. The differential pressure sensor 116a, the differential pressure sensor 116b, and the pressure sensor 118 communicate pressure data to the controller 102 via an example network 120. In some examples, the PRV 104 and the PRV 106 include data transmitters to wirelessly communicate with the network 120. In some examples, the differential pressure sensor 116b measures the pressure difference in the PRV 106 as well as the pressure in the inlet 112b, without the pressure sensor 118. In other examples, the PRV 106 includes two pressure sensors 118 to read pressure in the inlet and within the PRV 106 (e.g., a fluid pressure in a dome, a fluid pressure opposite a main relieving valve, etc.) to determine the differential pressure and the inlet pressure.

The example fluid system 108 of FIG. 1 is shown with two vessels 110, the PRV 104, and the PRV 106. The controller 102 receives pressure data from the differential pressure sensor 116a of the PRV 104, the differential pressure sensor 116b of the PRV 106, and the pressure sensor 118 of the PRV 106. In other examples, the fluid system 108 can include any number of vessels 110, each vessel 110 including a PRV 104 or a PRV 106 that transmits pressure data to the controller 102.

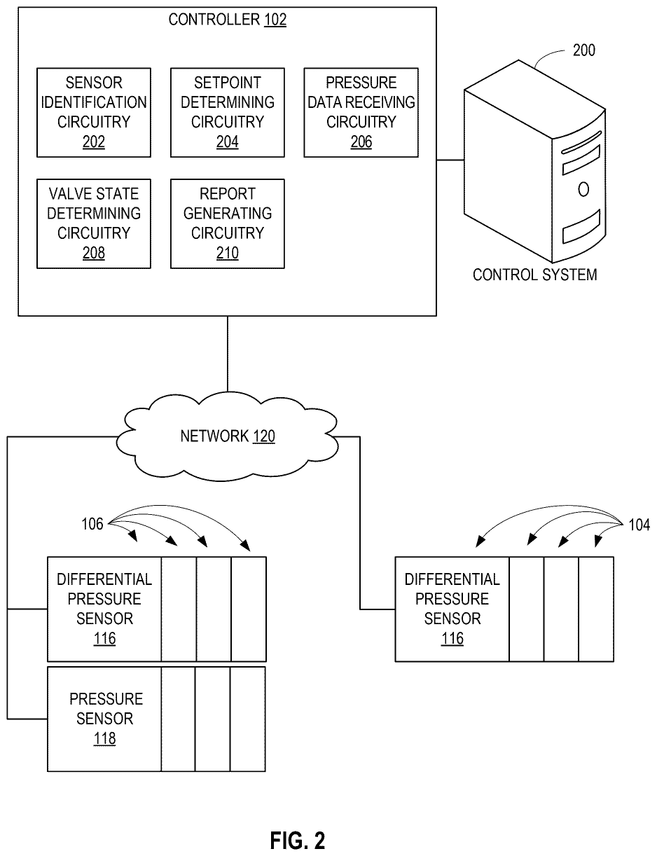

FIG. 2 is a block diagram of an example implementation of the controller 102 of FIG. 1 to determine if a PRV is near activation. The controller 102 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the controller 102 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example controller 102 of FIG. 2 communicates with an example control system 200 and the network 120. The network 120 receives data from one or more PRVs 106 and/or PRVs 104. In some examples, the PRVs 106 and/or the PRVs 104 communicate directly with the controller 102 without the use of the network 120. The PRVs 106 include a differential pressure sensor 116 and a pressure sensor 118. The PRVs 104 include a differential pressure sensor 116. The controller 102 includes example sensor identification circuitry 202, example setpoint determining circuitry 204, example pressure data receiving circuitry 206, example valve state determining circuitry 208, and example indication generating circuitry 210.

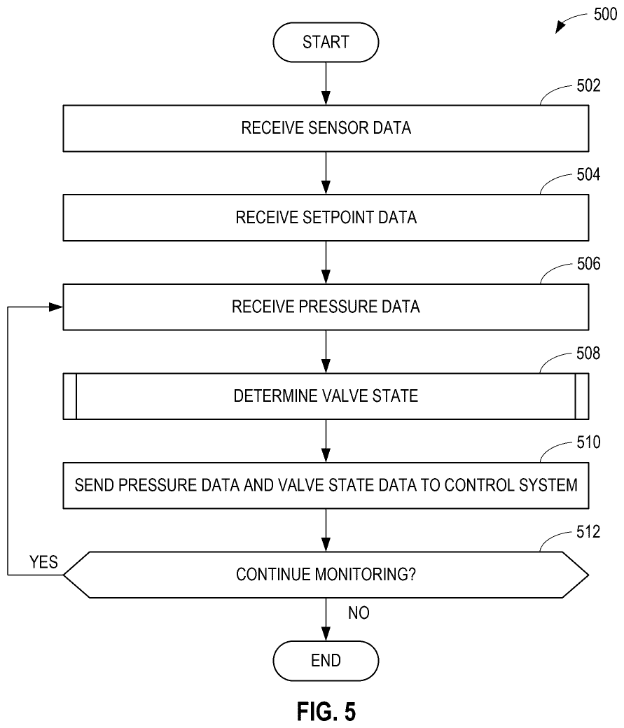

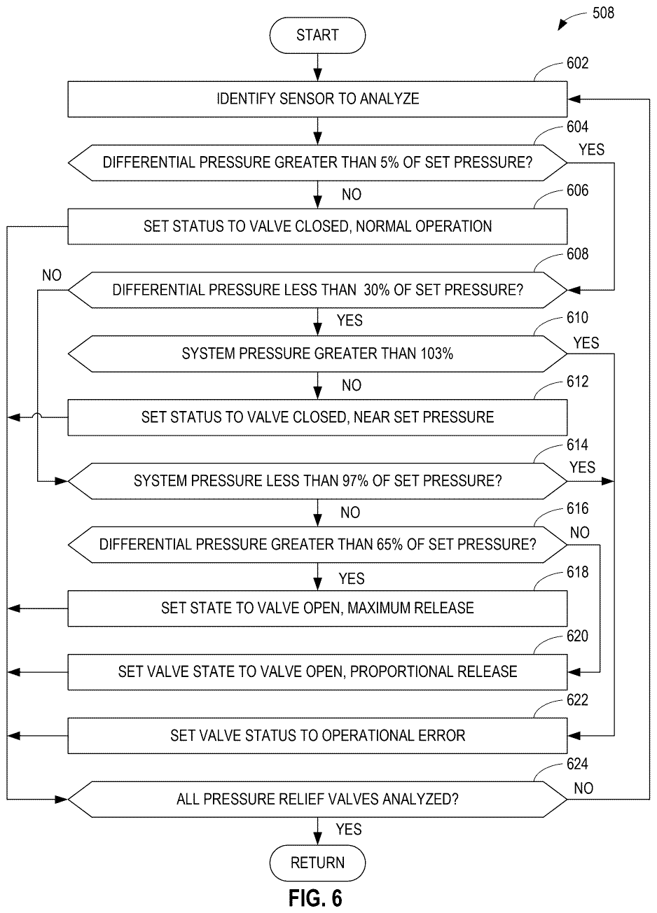

The sensor identification circuitry 202 associates data received from pressure sensors (e.g., the differential pressure sensor 116, the pressure sensor 118, etc.) with a specific pressure relief valve (e.g., the PRV 106, the PRV 104, etc.) within a fluid system (e.g., the fluid system 108). In this way, valve states generated by the valve state determining circuitry 208 can be associated with the corresponding pressure relief valves within the fluid system to be presented to the user and/or control system 200. In some examples, the sensor identification circuitry 202 generates sensor identification data corresponding to the pressure sensors within the fluid system. In some examples, the sensor identification circuitry 202 is instantiated by programmable circuitry executing sensor identification instructions and/or configured to perform operations such as those represented by the flowcharts of FIGS. 5 and 6.

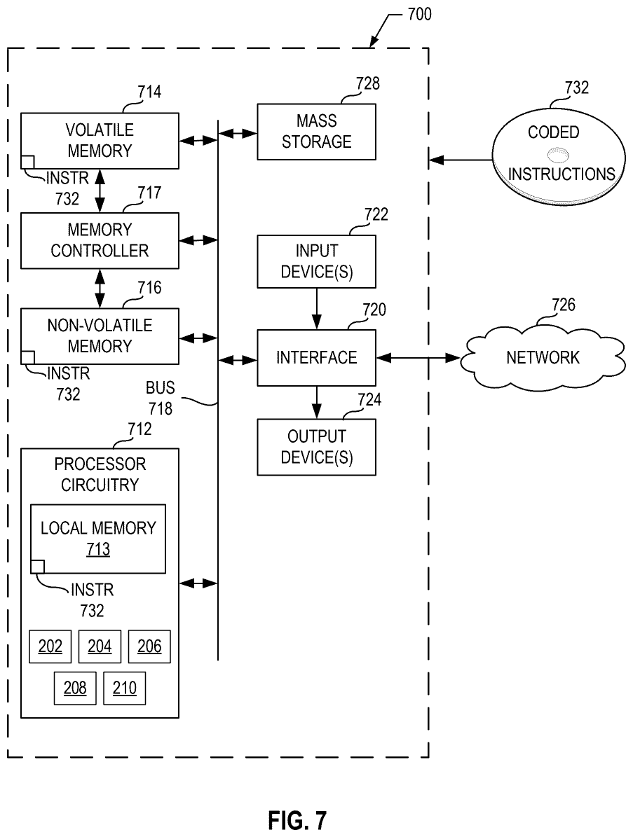

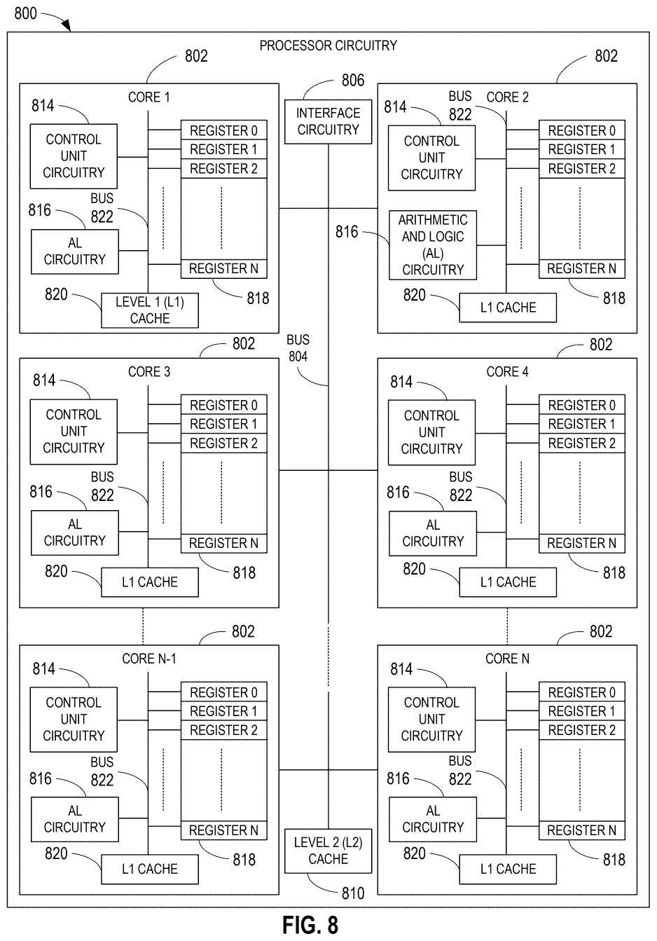

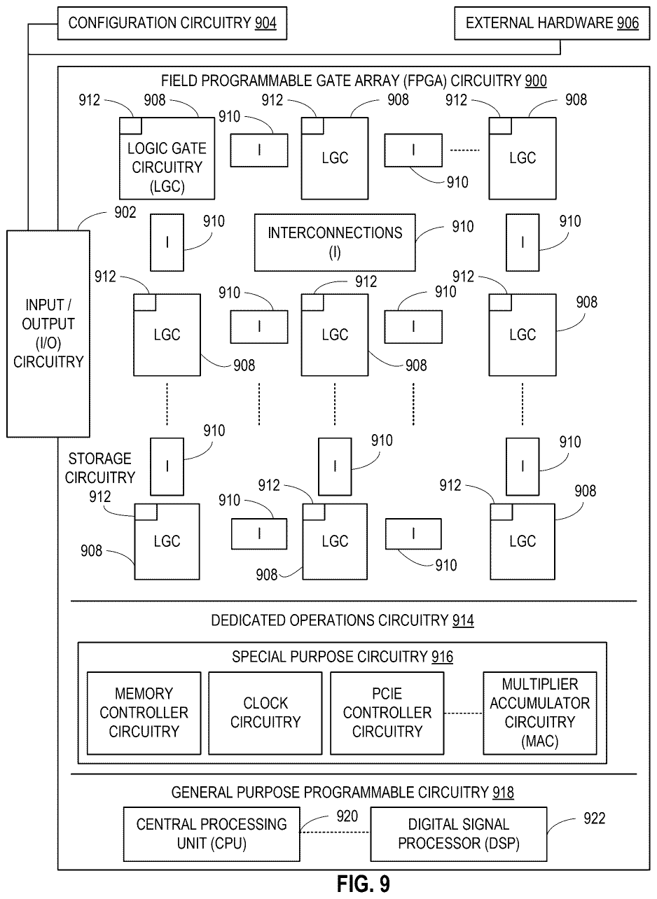

In some examples, the controller includes means for identifying sensors. For example, the means for identifying may be implemented by sensor identification circuitry 202. In some examples, the sensor identification circuitry 202 may be instantiated by programmable circuitry such as the example programmable circuitry 712 of FIG. 7. For instance, the sensor identification circuitry 202 may be instantiated by the example microprocessor 800 of FIG. 8 executing machine executable instructions such as those implemented by at least blocks 502 and 602 of FIGS. 5 and 6. In some examples, sensor identification circuitry 202 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the sensor identification circuitry 202 may be instantiated by any other combination of hardware, software, and/or firmware. For example, the sensor identification circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The setpoint determining circuitry 204 receives and or determines functional setpoints of the pressure relief valves associated with the pressure sensors. The pressure relief valve has an activation setpoint (e.g., a threshold pressure value, a set pressure, an activation differential pressure, an activation gauge pressure, etc.) that causes the pressure relief valve to activate or otherwise allow fluid to flow from the inlet to the outlet. In other words, the activation setpoint is a maximum pressure that is allowed in the pressure vessel.

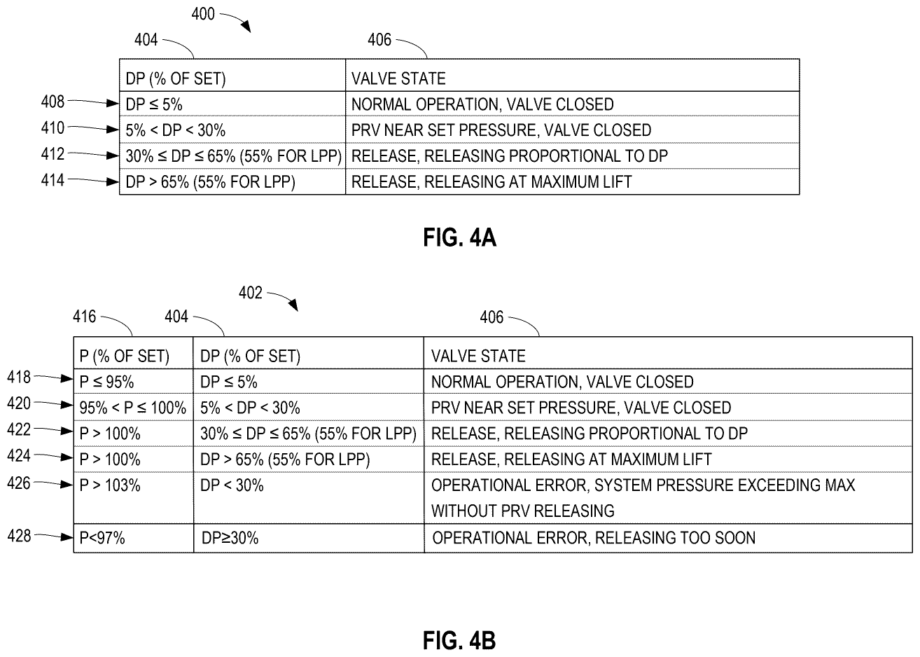

In some examples, the pressure relief valve includes other functional setpoints that describe other behaviors (e.g., operational states) of the pressure relief valve. For example, setpoint data received by the setpoint determining circuitry 204 can include a lower threshold pressure (e.g., minimum threshold pressure, lower threshold differential pressure, etc.) that corresponds to the pressure relief valve nearing the activation setpoint. In this way, the lower threshold pressure acts as an early indicator that the pressure relief valve will soon activate. In some examples, the setpoint data received by the setpoint determining circuitry 204 includes an upper threshold pressure (e.g., maximum threshold pressure, upper threshold differential pressure) that corresponds to a maximum opening of the pressure relief valve. As described in further detail below in reference to FIGS. 3A-3C, some example pressure relief valves open proportionally to a pressure within the pressure relief valve. In this way, the activation setpoint and the upper threshold pressure define a range of proportional fluid release of the pressure relief valve. In some examples, the setpoint data received by the setpoint determining circuitry 204 includes differential pressures associated with the functions of the pressure relief valve. In other examples, the setpoint data received by the setpoint determining circuitry 204 includes a gauge pressure activation setpoint and ratios (e.g., percentages of the gauge pressure activation setpoint) that the setpoint determining circuitry 204 uses to determine (e.g., calculate) other operational set points, as further detailed below in relation to FIGS. 4A and 4B. In some examples, the setpoint determining circuitry 204 is instantiated by programmable circuitry executing setpoint determining instructions and/or configured to perform operations such as those represented by the flowcharts of FIGS. 5 and 6.

In some examples, the controller includes means for determining a setpoint of a pressure relief valve. For example, the means for determining may be implemented by setpoint determining circuitry 204. In some examples, the setpoint determining circuitry 204 may be instantiated by programmable circuitry such as the example programmable circuitry 712 of FIG. 7. For instance, the setpoint determining circuitry 204 may be instantiated by the example microprocessor 800 of FIG. 8 executing machine executable instructions such as those implemented by at least blocks 504, 508, 604, 608, 612, and 620 of FIGS. 5 and 6. In some examples, the setpoint determining circuitry 204 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the setpoint determining circuitry 204 may be instantiated by any other combination of hardware, software, and/or firmware. For example, the setpoint determining circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The pressure data receiving circuitry 206 receives pressure data from pressure sensors in the system (e.g., the differential pressure sensors 116, the pressure sensors 118, etc.) for later use by the valve state determining circuitry 208. In some examples, the pressure data receiving circuitry 206 receives data in substantially real time from the pressure sensors. In some examples, the pressure data receiving circuitry 206 receives raw signal data from the pressure sensors (e.g., a voltage, an electric current, etc.) and converts the raw signal data into usable pressure measurements. In some examples, the pressure data receiving circuitry 206 determines if the pressure data is a differential pressure measurement or a gauge pressure measurement. In some examples, the pressure data receiving circuitry 206 is instantiated by programmable circuitry executing pressure data receiving instructions and/or configured to perform operations such as those represented by the flowchart of FIG. 5.

In some examples, the controller includes means for receiving pressure data. For example, the means for receiving may be implemented by pressure data receiving circuitry 206. In some examples, the pressure data receiving circuitry 206 may be instantiated by programmable circuitry such as the example programmable circuitry 712 of FIG. 7. For instance, the pressure data receiving circuitry 206 may be instantiated by the example microprocessor 800 of FIG. 8 executing machine executable instructions such as those implemented by at least blocks 506 of FIG. 5. In some examples, pressure data receiving circuitry 206 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the pressure data receiving circuitry 206 may be instantiated by any other combination of hardware, software, and/or firmware. For example, the pressure data receiving circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The valve state determining circuitry 208 compares pressure data received from the pressure data receiving circuitry 206 and setpoint data received from the setpoint determining circuitry 204 to determine a state of a pressure relief valve. For example, if the valve state determining circuitry 208 determines that a pressure measurement from a pressure relief valve is less than a lower threshold, the valve state determining circuitry 208 assigns a state of normal operation to the pressure relief valve. Further valve states (e.g., operational states) and the methods of their determination are detailed below in relation to FIGS. 4A, 4B, and 6. In some examples, the valve state determining circuitry 208 is instantiated by programmable circuitry executing valve state determining instructions and/or configured to perform operations such as those represented by the flowcharts of FIGS. 5 and 6.

In some examples, the controller includes means for determining a state of a pressure relief valve. For example, the means for determining may be implemented by valve state determining circuitry 208. In some examples, the valve state determining circuitry 208 may be instantiated by programmable circuitry such as the example programmable circuitry 712 of FIG. 7. For instance, the valve state determining circuitry 208 may be instantiated by the example microprocessor 800 of FIG. 8 executing machine executable instructions such as those implemented by at least blocks 508, 602, 604, 606, 608, 610, 612, 614, 616, 618, 620, 622, and 624 of FIGS. 5 and 6. In some examples, the valve state determining circuitry 208 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the valve state determining circuitry 208 may be instantiated by any other combination of hardware, software, and/or firmware. For example, the valve state determining circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The report generating circuitry 210 compiles sensor identification data received from the sensor identification circuitry 202 and valve state data received from the valve state determining circuitry 208 into indication data to be sent to the control system 200. The indication data includes data on each pressure relief valve within the monitored fluid system that includes a pressure sensor sending data to the controller 102. The indication data allows users of the control system to determine the state of the pressure relief valves. In some examples, the indication data includes pressure data received from the pressure data receiving circuitry 206. In some examples, the report generating circuitry 210 is instantiated by programmable circuitry executing report instructions and/or configured to perform operations such as those represented by the flowchart of FIG. 5.

In some examples, the controller includes means for generating a report. For example, the means for generating may be implemented by report generating circuitry 210. In some examples, the report generating circuitry 210 may be instantiated by programmable circuitry such as the example programmable circuitry 712 of FIG. 7. For instance, the report generating circuitry 210 may be instantiated by the example microprocessor 800 of FIG. 8 executing machine executable instructions such as those implemented by at least block 510 of FIG. 5. In some examples, the report generating circuitry 210 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the report generating circuitry 210 may be instantiated by any other combination of hardware, software, and/or firmware. For example, the report generating circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the controller 102 of FIG. 1 is illustrated in FIG. 2, one or more of the elements, processes, and/or devices illustrated in FIG. 2 may be combined, divided, re-arranged, omitted, eliminated, and/or implemented in any other way. Further, the example sensor identification circuitry 202, the example setpoint determining circuitry 204, the example pressure data receiving circuitry 206, the example valve state determining circuitry 208, the example indication generating circuitry 210, and/or, more generally, the example controller 102 of FIG. 2, may be implemented by hardware alone or by hardware in combination with software and/or firmware. Thus, for example, any of the example sensor identification circuitry 202, the example setpoint determining circuitry 204, the example pressure data receiving circuitry 206, the example valve state determining circuitry 208, the example indication generating circuitry 210, and/or, more generally, the example controller 102, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example controller 102 of FIG. 2 may include one or more elements, processes, and/or devices in addition to, or instead of, those illustrated in FIG. 2, and/or may include more than one of any or all of the illustrated elements, processes and devices.

Flowcharts representative of example machine readable instructions, which may be executed by programmable circuitry to implement and/or instantiate the controller 102 of FIG. 2 and/or representative of example operations which may be performed by programmable circuitry to implement and/or instantiate the controller 102 of FIG. 2, are shown in FIGS. 5 and/or 6. The machine readable instructions may be one or more executable programs or portion(s) of one or more executable programs for execution by programmable circuitry such as the programmable circuitry 712 shown in the example processor platform 700 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 5 and/or 6, many other methods of implementing the example controller may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks, and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable, and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 5 and/or 6 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic, and/or electrical) hardware to retain information for a time period, but to exclude propagating signals and to exclude transmission media. Examples of non-transitory computer readable storage devices /d/ or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIGS. 3A-3C are illustrations of the example pressure relief valve (PRV) 106 of FIG. 1 in an example closed state 300, an example proportional release state 302, and an example maximum release state 304. The PRV 106 includes an example pilot 306 that allows an example fluid 307 to flow from the inlet 112 to an example dome 308. The dome 308 is an area opposite the inlet 112 relative to an example piston 310 (e.g., a valve, a flow control member, a cylinder, etc.). By allowing the fluid 307 to flow from the inlet 112 to the dome 308, the pilot 306 allows the piston 310 to maintain a seal as a pressure of the fluid 307 increases.

The pilot 306 is configured to selectively fluidly isolate the inlet 112 from the dome 308 once the pressure of the fluid 307 rises to a setpoint of the PRV 106. Once the dome 308 is fluidly isolated from the inlet 112, the pressure of the fluid 307 in the inlet 112 causes the pilot 306 to release fluid from the dome 308. Reduction of the fluid 307 in the dome 308 causes the piston 310 to move away from the inlet 112 to fluidly couple the inlet 112 to the outlet 114. In other words, the PRV 106 selectively fluidly couples the inlet 112 to the outlet 114 when the pressure of the fluid 307 rises to a set pressure of the PRV 106. Conversely, the pilot 306 selectively fluidly couples the inlet 112 to the dome 308 when the pressure of the fluid 307 in the inlet 112 falls below the set pressure of the PRV 106. Once the dome 308 and the inlet 112 are fluidly coupled, the fluid 307 returns to the dome 308 and pushes the piston 310 towards the inlet 112 to fluidly isolate the inlet 112 from the outlet 114.

FIG. 3A shows the dome 308 of PRV 106 fluidly coupled to the inlet 112 via the pilot 306. The differential pressure sensor 116 measures a pressure difference between the inlet 112 and the dome 308. In the example of FIG. 3A, the differential pressure sensor 116 generates pressure data that corresponds to a differential pressure at or near zero. In other words, the dome 308 and the inlet 112 of FIG. 3A are fluidly coupled and experience the same pressure from the fluid 307. The pressure sensor 118 measures a gauge pressure of the inlet 112. In the example of FIG. 3A, the pressure sensor 118 generates pressure data that corresponds to a fluid pressure that is less than the set pressure of the PRV 106.

FIG. 3B shows the dome 308 of PRV 106 fluidly isolated from the inlet 112 via the pilot 306. Additionally, an example fluid 312 in the dome 308 is being released by the pilot 306 to reduce the pressure of fluid 312 within the dome. In the example of FIG. 3B, the differential pressure sensor 116 generates pressure data that corresponds to a positive differential pressure. In other words, the dome 308 and the inlet 112 of FIG. 3B are fluidly isolated and the pressure from the fluid 307 is higher than the pressure from fluid 312. In the example of FIG. 3B, the pressure sensor 118 generates pressure data that corresponds to a fluid pressure that is approximately equal to the set pressure of the PRV 106. The PRV 106 of FIG. 3B shows the piston 310 releasing fluid 307 proportionally to the differential pressure between the dome 308 and the inlet 112. In FIG. 3B, the piston 310 has begun to move and the fluid 307 flows from the inlet 112 to the outlet 114 at a relatively low rate.

FIG. 3C shows the dome 308 of PRV 106 fluidly isolated from the inlet 112 via the pilot 306. Additionally, most of the fluid 312 has been released by the pilot 306. In this example, the differential pressure sensor 116 generates pressure data that corresponds to a differential pressure that is near the set pressure (e.g., the activation pressure of the PRV 106). In other words, the dome 308 and the inlet 112 of FIG. 3C are fluidly isolated, and the gauge pressure in the dome 308 is near zero (e.g., near atmospheric pressure). In the example of FIG. 3C, the pressure sensor 118 generates pressure data that corresponds to a fluid pressure that is approximately equal to the set pressure of the PRV 106. As depicted in FIG. 3C, the piston 310 has moved away from the inlet 112 and come to rest (e.g., has reached a maximum lift position, has reached a maximum distance from the inlet 112, etc.). In this way, the PRV 106 is fully open and releases the fluid 307 to the outlet 114.

FIGS. 4A-4B are example operational charts 400, 402 that can be used to determine operational states of the example pressure relief valves (PRV) 104, 106 of FIG. 1. FIG. 4A shows the operational chart 400 that corresponds to a PRV that includes a single differential pressure sensor to measure differential pressure across an inlet and a dome of the PRV (e.g., the PRV 104). The operational chart 400 shows example operational thresholds 404 of differential pressure and example resulting valve states 406. The operational thresholds 404 are described as percentages of the set pressure (e.g., activation pressure, activation setpoint, etc.) of the PRV being described.

Row 408 of the operational chart 400 shows that, if the differential pressure between the inlet and the dome is 5% or less of the set pressure, the PRV has a valve state corresponding to normal operation with the valve in a closed position. Row 410 of the operational chart 400 shows that, if the differential pressure between the inlet and the dome is more than 5% of the set pressure, but less than 30% of the set pressure, the PRV has a valve state corresponding to near set pressure with the valve in a closed position. In some examples, the 5% threshold (e.g., lower threshold) between the normal operation state and the near setpoint pressure state can be changed by a user to a different value (e.g., between 0% and 30% of the set pressure) to accommodate different system characteristics, such as pulsing pressure changes.

Row 412 of the operational chart 400 shows that, if the differential pressure between the inlet and the dome is 30% or more of the set pressure, but 65% or less of the set pressure, the PRV has a valve state corresponding to release with the valve releasing (e.g. in an open position) proportionally to differential pressure. In other words, the PRV begins releasing when the differential pressure is at 30% of the set pressure and proportionally increases the release (e.g., the distance between the inlet 112 and the piston 310 of FIGS. 3A-3C) until the differential pressure reaches 65% of the set pressure. In some examples, the PRV 106 has different features (e.g., a different ratio of a diameter of the cylinder to a diameter of the seat) that cause the 30% threshold for PRV activation to be different (e.g., 25%, 35%, etc.).

Row 414 of the operational chart 400 shows that, if the differential pressure between the inlet and the dome is greater than 65% of the setpoint pressure, the PRV has a valve state corresponding to release with the valve releasing at a maximum lift condition (e.g. fully open condition, etc.). In some examples, the PRV has different operational characteristics and the 65% threshold (e.g., upper threshold) between the valve releasing proportionally to differential pressure and the valve releasing at maximum lift can be a different number (e.g., 55% of the differential pressure) to reflect the different operational characteristics of the PRV.

The operational chart 402 of FIG. 4B includes the operational thresholds 404 of differential pressure and resulting valve states 406 that are shown in the operational chart 400. The operational chart 402 further includes example gauge pressure thresholds 416. The gauge pressure thresholds 416 serve as reference pressures for the valve states 406, as well as indicators of malfunction in the PRV. Row 418 of the operational chart 402 includes the values in row 408 with a gauge pressure measurement of 95% or less of the set pressure, correlating to the PRV having a valve state of normal operations with the valve in a closed state. Row 420 of the operational chart 402 includes the values in row 410 with a gauge pressure measurement of more than 95% and up to 100% of the set pressure, correlating to the PRV having a valve state of near set pressure with the valve in a closed state. Row 422 of the operational chart 402 includes the values in the row 412 with a gauge pressure measurement of more than 100% set pressure, correlating to the PRV having a valve state of release and the valve releasing proportionally to differential pressure. Row 424 of the operational chart 402 includes the values in the row 414 with a gauge pressure measurement of more than 100% set pressure, correlating to the PRV having a valve state of release and the valve in a maximum release position.

Row 426 of the operational chart 402 shows that, if the gauge pressure is more than 103% of the set pressure and the differential pressure is less than 30% of the set pressure, the PRV has a state of operational error (e.g., an operational error state), where the system pressure is above a maximum allowable working pressure without evidence of the PRV releasing. Row 428 of the operational chart 402 shows that, if the gauge pressure is less than 97% of the set pressure and the differential pressure is at least 30% of the set pressure, the PRV has a valve state of operational error, where the PRV is releasing below the set pressure. In this way, row 426 and row 428 show that adding a gauge pressure reading at the inlet of the PRV allows operational errors or other changes to be detected.

The operational charts 400, 402 show examples of how measured pressures can be correlated to valve states. In other examples, such as PRV valves that are designed to work with vacuum, the setpoints for differential pressure and/or gauge pressure can be different to suit the specific method of activation of the PRV.

FIG. 5 is a flowchart representative of example machine readable instructions and/or example operations 500 that may be executed, instantiated, and/or performed by programmable circuitry to determine operational states of pressure relief valves. The example machine-readable instructions and/or the example operations 500 of FIG. 5 begin at block 502, at which the sensor identification circuitry 202 receives (e.g., obtains) sensor data from pressure sensors (e.g., the differential pressure sensor 116, the pressure sensor 118, etc.) that measure pressure within PRVs (e.g., the PRV 104, the PRV 106) within the fluid system (e.g., the fluid system 108). The sensor data includes identification data corresponding to the pressure sensors and the PRVs. In some examples, the sensor identification circuitry 202 receives sensor data and generates identification data based on the sensor data.

The operations 500 of FIG. 5 continue to block 504, at which the setpoint determining circuitry 204 receives (e.g., obtains) setpoint data corresponding to the PRVs. The setpoint data includes data corresponding to set pressures (e.g., activation pressures) of the PRVs within the fluid system. The setpoint data includes example thresholds that describe operational characteristics (e.g., a state of near set pressure, a state of release proportional to differential pressure, a state of release at maximum lift, a state of operational error, etc.) of the PRVs within the fluid system. In this way, each PRV in the fluid system is identified by the sensor identification circuitry 202 and defined with setpoints received by the setpoint determining circuitry 204. In some examples, the setpoint data includes gauge pressure measurements and/or differential pressure measurements that correspond to the set pressures and thresholds. In other examples, the setpoint data includes multipliers (e.g., ratios, percentages, etc.) of set pressure that correspond to the thresholds. For example, the setpoint data could include a set pressure of 100 pounds per square inch and a threshold of 65% of set pressure, which would be interpreted by the setpoint determining circuitry 204 and/or the valve state determining circuitry 208 as a threshold pressure of 65 pounds per square inch.

The operations 500 of FIG. 5 continue to block 506, at which the pressure data receiving circuitry 206 receives (e.g., obtains) pressure data from the sensors within the fluid system. In some examples, the pressure data includes differential and/or gauge pressures from each PRV. In some examples, the pressure data includes signal data (e.g., a voltage signal, a current signal, etc.) from the pressure sensors that is converted to pressure data by the pressure data receiving circuitry 206.

The operations 500 of FIG. 5 continue to block 508, at which the valve state determining circuitry determines a state of the valve. Further detailed below in relation to FIG. 6, the valve state determining circuitry compares the sensor identification data, the setpoint data, and the pressure data to determine a state of the valves within the PRVs. The operations 500 continue to block 510, at which the report generating circuitry 210 sends pressure data and valve state data to a control system (e.g., the control system 200). In this way, the valve states corresponding to the PRVs in the fluid system are reported to the control system and the users of the control system. The operations 500 continue to block 512, where the controller 102 determines if the PRVs should continue to be monitored. In some examples, the controller 102 will continue monitoring until a user input is received to stop. If the controller 102 is to continue monitoring, the operations 500 move to block 506 where pressure data is received. If the controller is not to continue monitoring, the operations 500 end.

FIG. 6 is a flowchart representative of example machine readable instructions and/or example operations 508 that may be executed, instantiated, and/or performed by programmable circuitry to determine valve states. The example machine-readable instructions and/or the example operations 508 of FIG. 6 begin at block 602, at which the valve state determining circuitry 208 identifies a sensor to analyze. In some examples, the valve state determining circuitry 208 chooses a sensor from the sensor identification data generated by the sensor identification circuitry 202. The operations 508 continue to block 604, at which the valve state determining circuitry 208 determines if the differential pressure reading corresponding to the identified sensor is greater than 5% of the set pressure of the corresponding PRV. In other words, the valve state determining circuitry 208 compares pressure data from the pressure data receiving circuitry 206 to setpoint data received from the setpoint determining circuitry 204 to determine if the pressure data is greater than the lower threshold pressure. If the differential pressure is not greater than 5% of the set pressure, the operations continue to block 606, at which the valve state determining circuitry 208 assigns a valve state of valve closed, normal operation. The operations 508 move to block 624, where the valve state determining circuitry 208 determines if all PRVs have been analyzed. If all PRVs have been analyzed, the operations 508 return to the operations 500 of FIG. 5. If not all PRVs have been analyzed, the operations 508 return to block 602, at which the valve state determining circuitry 208 identifies a new pressure sensor to analyze.

Returning to block 604, if the differential pressure is greater than 5% of the set pressure, the operations 508 move to block 608, where the valve state determining circuitry 208 determines if the differential pressure is less than 30% of set pressure. In this example, 30% of the set pressure corresponds to a differential activation pressure of the PRV. If the differential pressure is less than 30% of set pressure, the operations 508 move to block 610, where the valve state determining circuitry 208 determines if the system pressure is greater than 103%. If the system pressure is not greater than 103%, or if there is no system pressure measurement correlated to the PRV being analyzed, the operations 508 move to block 612, at which the at valve state determining circuitry 208 assigns a valve state of valve closed, near set pressure. The operations 508 move to block 624, where the valve state determining circuitry 208 determines if all PRVs have been analyzed. If all PRVs have been analyzed, the operations 508 return to the operations 500 of FIG. 5. If not all PRVs have been analyzed, the operations 508 return to block 602, at which the valve state determining circuitry 208 identifies a new pressure sensor to analyze.

Returning to block 610, if the valve state determining circuitry 208 determines that system pressure is greater than 103% of the set pressure, the operations 508 move to block 622, at which the at valve state determining circuitry 208 assigns a valve state of operational error. The operational error in this example is that the system pressure exceeds the maximum allowable working pressure of the PRV without the PRV activating. The operations 508 move to block 624, where the valve state determining circuitry 208 determines if all PRVs have been analyzed. If all PRVs have been analyzed, the operations 508 return to the operations 500 of FIG. 5. If not all PRVs have been analyzed, the operations 508 return to block 602, at which the valve state determining circuitry 208 identifies a new pressure sensor to analyze.

Returning to block 608, if the valve state determining circuitry 208 determines that the differential pressure is not less than 30% of the set pressure, the operations 508 move to block 614, at which the valve state determining circuitry 208 determines if the system pressure is less than 97% of the set pressure. If the system pressure is less than 97% of the set pressure, the operations 508 move to block 622, at which the at valve state determining circuitry 208 assigns a valve state of operational error. The operational error in this example is that PRV is activating when the system pressure is below the set pressure (e.g., the PRV is releasing too soon). The operations 508 move to block 624, where the valve state determining circuitry 208 determines if all PRVs have been analyzed. If all PRVs have been analyzed, the operations 508 return to the operations 500 of FIG. 5. If not all PRVs have been analyzed, the operations 508 return to block 602, at which the valve state determining circuitry 208 identifies a new pressure sensor to analyze.

Returning to block 614, if the valve state determining circuitry 208 determines that the system pressure is not less than 97% of the set pressure, the operations 508 continue to block 616. At block 616, the valve state determining circuitry 208 determines if the differential pressure is greater than 65% of the set pressure. In this example, 65% of the set pressure corresponds to an upper threshold setpoint of the PRV. If the differential pressure is not greater than 65% of the set pressure, then the operations 508 move to block 620, at which the valve state determining circuitry 208 sets a valve state of valve open with proportional release. In other words, the valve state determining circuitry 208 determines that the PRV has begun to open and release fluid but has not yet reached the maximum lift. The operations 508 move to block 624, where the valve state determining circuitry 208 determines if all PRVs have been analyzed. If all PRVs have been analyzed, the operations 508 return to the operations 500 of FIG. 5. If not all PRVs have been analyzed, the operations 508 return to block 602, at which the valve state determining circuitry 208 identifies a new pressure sensor to analyze.

Returning to block 616, if the valve state determining circuitry 208 determines that the differential pressure is greater than 65% of the set pressure, then the operations 508 continue to block 618. At block 618, the valve state determining circuitry 208 sets a valve state of valve open with maximum release. In other words, the valve state determining circuitry 208 determines that the PRV has reached the maximum lift of the valve, and the PRV is releasing fluid at a maximum rate. The operations 508 move to block 624, where the valve state determining circuitry 208 determines if all PRVs have been analyzed. If all PRVs have been analyzed, the operations 508 return to the operations 500 of FIG. 5. If not all PRVs have been analyzed, the operations 508 return to block 602, at which the valve state determining circuitry 208 identifies a new pressure sensor to analyze.

FIG. 7 is a block diagram of an example programmable circuitry platform 700 structured to execute and/or instantiate the example machine-readable instructions and/or the example operations of FIGS. 5 and/or 6 to implement the controller 102 of FIG. 2. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, DSPs, and/or microcontrollers from any desired family or manufacturer. The programmable circuitry 712 may be implemented by one or more semiconductor based (e.g., silicon based) devices. In this example, the programmable circuitry 712 implements the sensor identification circuitry 202, the setpoint determining circuitry 204, the pressure data receiving circuitry 206, the valve state determining circuitry 208, and the report generating circuitry 210.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 732, which may be implemented by the machine readable instructions of FIGS. 5 and/or 6, may be stored in the mass storage device 728, in the volatile memory 714, in the non-volatile memory 716, and/or on at least one non-transitory computer readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowcharts of FIGS. 5 and/or 6 to effectively instantiate the circuitry of FIG. 2 as logic circuits to perform operations corresponding to those machine readable instructions. In some such examples, the circuitry of FIG. 2 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowcharts of FIGS. 5 and/or 6.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)), and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine readable instructions represented by the flowchart(s) of FIGS. 5 and/or 6 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 5 and/or 6. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 5 and/or 6. As such, the FPGA circuitry 900 may be configured and/or structured to effectively instantiate some or all of the operations/functions corresponding to the machine readable instructions of the flowchart(s) of FIGS. 5 and/or 6 as dedicated logic circuits to perform the operations/functions corresponding to those software instructions in a dedicated manner analogous to an ASIC. Therefore, the FPGA circuitry 900 may perform the operations/functions corresponding to the some or all of the machine readable instructions of FIGS. 5 and/or 6 faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine readable instructions of FIGS. 5 and/or 6 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 8. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine readable instructions represented by the flowchart(s) of FIGS. 5 and/or 6 to perform first operation(s)/function(s), the FPGA circuitry 900 of FIG. 9 may be configured and/or structured to perform second operation(s)/function(s) corresponding to a second portion of the machine readable instructions represented by the flowcharts of FIGS. 5 and/or 6, and/or an ASIC may be configured and/or structured to perform third operation(s)/function(s) corresponding to a third portion of the machine readable instructions represented by the flowcharts of FIGS. 5 and/or 6.

It should be understood that some or all of the circuitry of FIG. 2 may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 800 of FIG. 8 may execute machine readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the circuitry of FIG. 2 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that determine if a pressure relief valve is nearing activation based on a differential pressure measurement and operational thresholds of the pressure relief valve. In this way, disclosed systems, apparatus, articles of manufacture, and methods allow monitoring systems and/or control systems of pressure systems provide an indication to control systems and/or users managing the fluid system that pressures within the fluid system are nearing the maximum allowable working pressure. This indication allows corrective actions or other preparations to be performed before the pressure relief valves vent fluids. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to determine if a pressure relief valve is nearing activation are disclosed herein. Further examples and combinations thereof include the following:

Example 1 includes a computing device including interface circuitry, machine readable instructions, and programmable circuitry to at least one of instantiate or execute the machine readable instructions to obtain pressure data from a pressure sensor, the pressure data associated with a differential pressure between a first area of a pressure relief valve and a second area of the pressure relief valve, the first area different than the second area, to obtain setpoint data corresponding to a threshold pressure and an activation pressure of the pressure relief valve, to determine if the differential pressure is between the threshold pressure and the activation pressure based on the pressure data and the setpoint data, and to generate an indication corresponding to the differential pressure being between the threshold pressure and the activation pressure.

Example 2 includes the computing device of example 1, wherein the indication corresponds to the pressure relief valve being near activation.

Example 3 includes the computing device of any one of examples 1 or 2, wherein the first area is an inlet of the pressure relief valve and the second area is a dome of the pressure relief valve.

Example 4 includes the computing device of example 3, wherein the programmable circuitry is further to determine a state of the pressure relief valve based on the pressure data and the setpoint data, and generate a second indication corresponding to the state of the pressure relief valve.

Example 5 includes the computing device of example 4, wherein determining the state of the pressure relief valve includes determining if the differential pressure is below the activation pressure based on the pressure data and the setpoint data, and generating the second indication includes generating an indication corresponding to a closed state of the pressure relief valve.

Example 6 includes the computing device of any one of examples 4 or 5, wherein the setpoint data includes a second threshold pressure, the second threshold pressure greater than the activation pressure, determining the state of the pressure relief valve includes determining if the differential pressure is greater than the activation pressure and less than the second threshold pressure based on the pressure data and the setpoint data, and generating the second indication includes generating an indication corresponding to a proportional release state of the pressure relief valve.

Example 7 includes the computing device of any one of examples 4-6, wherein the setpoint data includes a second threshold pressure, the second threshold pressure greater than the activation pressure, determining the state of the pressure relief valve includes determining if the differential pressure is greater than the second threshold pressure based on the pressure data and the setpoint data, and generating the second indication includes generating an indication corresponding to a maximum release state of the pressure relief valve.

Example 8 includes the computing device of any one of examples 4-7, wherein obtaining the pressure data includes obtaining pressure data from a second pressure sensor, the second pressure sensor to generate a gauge pressure measurement associated with the second area, the setpoint data includes an activation gauge pressure, determining the state of the pressure relief valve includes determining if the gauge pressure measurement is greater than the activation gauge pressure and the differential pressure is less than the activation pressure based on the pressure data and the setpoint data, and generating the second indication includes generating an indication corresponding to an operational error state of the pressure relief valve.

Example 9 includes the computing device of any one of examples 1-8, wherein the setpoint data is received via a user input.

Example 10 includes a non-transitory machine readable storage medium comprising instructions to cause programmable circuitry to at least obtain sensor identification data corresponding to a sensor operatively coupled to a pressure relief valve within a fluid system, the pressure relief valve coupled to a pressure vessel, obtain setpoint data corresponding to an activation differential pressure of the pressure relief valve, obtain pressure data from the sensor, the pressure data corresponding to a differential pressure across a flow control member within the pressure relief valve, the flow control member to selectively fluidly couple and selectively isolate an inlet of the pressure relief valve from an outlet of the pressure relief valve based on the differential pressure rising above or falling below the activation differential pressure of the pressure relief valve, and determine a state of the pressure relief valve based on the sensor identification data, the setpoint data, and the pressure data.

Example 11 includes the non-transitory machine readable storage medium of example 10, wherein the setpoint data includes a lower threshold differential pressure, the lower threshold differential pressure greater than zero and less than the activation differential pressure, and wherein determining the state of the pressure relief valve includes determining if the differential pressure is above the lower threshold differential pressure and below the activation differential pressure.

Example 12 includes the non-transitory machine readable storage medium of example 11, wherein the setpoint data is obtained via a user input and the lower threshold differential pressure is defined by a user input.

Example 13 includes the non-transitory machine readable storage medium of any one of examples 10-12, wherein the setpoint data includes an upper threshold differential pressure, the upper threshold differential pressure corresponding to the flow control member being at a maximum distance from the inlet, and wherein determining the state of the pressure relief valve includes determining if the differential pressure is at or above the upper threshold differential pressure.

Example 14 includes the non-transitory machine readable storage medium of example 13, wherein determining the state of the pressure relief valve includes determining if the differential pressure is above the activation differential pressure and below the upper threshold differential pressure.

Example 15 includes the non-transitory machine readable storage medium of any one of examples 10-14, wherein the instructions further cause the programmable circuitry to obtain sensor identification data corresponding to a second sensor operatively coupled to the inlet of the pressure relief valve, obtain setpoint data corresponding to an activation gauge pressure of the pressure relief valve, and obtain pressure data from the second sensor corresponding to a pressure in the inlet.

Example 16 includes the non-transitory machine readable storage medium of example 15, wherein determining the state of the pressure relief valve includes determining if the pressure in the inlet is greater than the activation gauge pressure and if the differential pressure is below the activation differential pressure.

Example 17 includes a method of detecting a pressure relief valve nearing activation including receiving sensor data corresponding to an identification of a pressure sensor within a fluid system, the pressure sensor to measure pressure within the pressure relief valve, the pressure relief valve including an inlet and a dome, receiving setpoint data corresponding to an activation pressure of the pressure relief valve, receiving pressure data from the pressure sensor, and determining if the pressure relief valve is nearing activation based on the sensor data, the pressure data, and the setpoint data.

Example 18 includes the method of example 17, further including sending the sensor data corresponding to the identification of the pressure relief valve determined to be nearing activation to a control system.

Example 19 includes the method of any one of examples 17 or 18, wherein the setpoint data includes a minimum threshold pressure of the pressure relief valve and determining if the pressure relief valve is nearing activation includes determining if the pressure data is between the minimum threshold pressure and the activation pressure.

Example 20 includes the method of any one of examples 17-19, wherein the setpoint data includes a maximum threshold pressure of the pressure relief valve and determining if the pressure relief valve is nearing activation includes determining if the pressure data is between the activation pressure and the maximum threshold pressure.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A computing device comprising:
interface circuitry;
machine readable instructions; and
programmable circuitry to at least one of instantiate or execute the machine readable instructions to:
obtain pressure data from a pressure sensor, the pressure data associated with a differential pressure between a first area of a pressure relief valve and a second area of the pressure relief valve, the first area different than the second area;
obtain setpoint data corresponding to a threshold pressure and an activation pressure of the pressure relief valve;
determine if the differential pressure is between the threshold pressure and the activation pressure based on the pressure data and the setpoint data; and
generate an indication corresponding to the differential pressure being between the threshold pressure and the activation pressure.

2. The computing device of claim 1, wherein the indication corresponds to the pressure relief valve being near activation.

3. The computing device of claim 1, wherein the first area is an inlet of the pressure relief valve and the second area is a dome of the pressure relief valve.

4. The computing device of claim 3, wherein the programmable circuitry is further to:
determine a state of the pressure relief valve based on the pressure data and the setpoint data; and
generate a second indication corresponding to the state of the pressure relief valve.

5. The computing device of claim 4, wherein determining the state of the pressure relief valve includes determining if the differential pressure is below the activation pressure based on the pressure data and the setpoint data, and generating the second indication includes generating an indication corresponding to a closed state of the pressure relief valve.

6. The computing device of claim 4, wherein:
the setpoint data includes a second threshold pressure, the second threshold pressure greater than the activation pressure;
determining the state of the pressure relief valve includes determining if the differential pressure is greater than the activation pressure and less than the second threshold pressure based on the pressure data and the setpoint data; and
generating the second indication includes generating an indication corresponding to a proportional release state of the pressure relief valve.

7. The computing device of claim 4, wherein:
the setpoint data includes a second threshold pressure, the second threshold pressure greater than the activation pressure;
determining the state of the pressure relief valve includes determining if the differential pressure is greater than the second threshold pressure based on the pressure data and the setpoint data; and
generating the second indication includes generating an indication corresponding to a maximum release state of the pressure relief valve.

8. The computing device of claim 4, wherein:
obtaining the pressure data includes obtaining pressure data from a second pressure sensor, the second pressure sensor to generate a gauge pressure measurement associated with the second area;
the setpoint data includes an activation gauge pressure;
determining the state of the pressure relief valve includes determining if the gauge pressure measurement is greater than the activation gauge pressure and the differential pressure is less than the activation pressure based on the pressure data and the setpoint data; and
generating the second indication includes generating an indication corresponding to an operational error state of the pressure relief valve.

9. The computing device of claim 1, wherein the setpoint data is received via a user input.

10. A non-transitory machine readable storage medium comprising instructions to cause programmable circuitry to at least:
obtain sensor identification data corresponding to a sensor operatively coupled to a pressure relief valve within a fluid system, the pressure relief valve coupled to a pressure vessel;
obtain setpoint data corresponding to an activation differential pressure of the pressure relief valve;
obtain pressure data from the sensor, the pressure data corresponding to a differential pressure across a flow control member within the pressure relief valve, the flow control member to selectively fluidly couple and selectively isolate an inlet of the pressure relief valve from an outlet of the pressure relief valve based on the differential pressure rising above or falling below the activation differential pressure of the pressure relief valve; and
determine a state of the pressure relief valve based on the sensor identification data, the setpoint data, and the pressure data.

11. The non-transitory machine readable storage medium of claim 10, wherein the setpoint data includes a lower threshold differential pressure, the lower threshold differential pressure greater than zero and less than the activation differential pressure, and wherein determining the state of the pressure relief valve includes determining if the differential pressure is above the lower threshold differential pressure and below the activation differential pressure.

12. The non-transitory machine readable storage medium of claim 11, wherein the setpoint data is obtained via a user input and the lower threshold differential pressure is defined by a user input.

13. The non-transitory machine readable storage medium of claim 10, wherein the setpoint data includes an upper threshold differential pressure, the upper threshold differential pressure corresponding to the flow control member being at a maximum distance from the inlet, and wherein determining the state of the pressure relief valve includes determining if the differential pressure is at or above the upper threshold differential pressure.

14. The non-transitory machine readable storage medium of claim 13, wherein determining the state of the pressure relief valve includes determining if the differential pressure is above the activation differential pressure and below the upper threshold differential pressure.

15. The non-transitory machine readable storage medium of claim 10, wherein the instructions further cause the programmable circuitry to:
obtain sensor identification data corresponding to a second sensor operatively coupled to the inlet of the pressure relief valve;
obtain setpoint data corresponding to an activation gauge pressure of the pressure relief valve; and
obtain pressure data from the second sensor corresponding to a pressure in the inlet.

16. The non-transitory machine readable storage medium of claim 15, wherein determining the state of the pressure relief valve includes determining if the pressure in the inlet is greater than the activation gauge pressure and if the differential pressure is below the activation differential pressure.

17. A method of detecting a pressure relief valve nearing activation, the method comprising:
receiving sensor data corresponding to an identification of a pressure sensor within a fluid system, the pressure sensor to measure pressure within the pressure relief valve, the pressure relief valve including an inlet and a dome;
receiving setpoint data corresponding to an activation pressure of the pressure relief valve;
receiving pressure data from the pressure sensor; and
determining if the pressure relief valve is nearing activation based on the sensor data, the pressure data, and the setpoint data.

18. The method of claim 17, further including sending the sensor data corresponding to the identification of the pressure relief valve determined to be nearing activation to a control system.

19. The method of claim 17, wherein the setpoint data includes a minimum threshold pressure of the pressure relief valve and determining if the pressure relief valve is nearing activation includes determining if the pressure data is between the minimum threshold pressure and the activation pressure.

20. The method of claim 17, wherein the setpoint data includes a maximum threshold pressure of the pressure relief valve and determining if the pressure relief valve is nearing activation includes determining if the pressure data is between the activation pressure and the maximum threshold pressure.
